(19) United States
(12) Patent Application Publication
(10) Pub. No.: US 2009/0256357 A1
(43) Pub. Date: Oct. 15, 2009

(54) METHOD AND JOINT FOR SEALING

(75) Inventor: Peter HUSBERG, Vetlanda (SE)

Correspondence Address: YOUNG & THOMPSON, 209 Madison Street, Suite 500, ALEXANDRIA, VA, 22314, US

(73) Assignee: SAPA PROFILER AB, Vetlanda (SE)

(21) Appl. No.: 12/421,105

(22) Filed: Apr. 9, 2009

(30) Foreign Application Priority Data
Apr. 14, 2008 (SE) 0800837-7

(51) Int. Cl. F16L 13/14; F16L 33/18

(52) U.S. Cl. 285/382; 285/345

(57) ABSTRACT

The present invention relates to a method of sealing an opening in a tubular body (1), comprising at least one through channel (3) extending in the longitudinal direction of the body, an opening (7) of the channel being formed in respective end surface (5) of the body. The method is characterized in that a sealing plug (15) is inserted in the opening (7) and is positioned far enough into the channel (3) that when a stamping tool (19) with an outer diameter which is greater than the inner diameter of the opening (7) is applied perpendicularly to the end surface (5) and concentrically to the opening (7), the portion of the end surface (5) constituting the periphery of the opening (7) is deformed plastically and is pressed into the channel (3) to form a shoulder (21) outside the sealing plug (15) with an inner diameter which is less than the outer diameter of the sealing plug (15).

### TECHNICAL FIELD

The present invention relates to a method according to the preamble of claim 1.

The invention also relates to a sealing joint according to claim 7.

### BACKGROUND

Diesel engines are equipped with fuel injectors for injection of fuel to the cylinders. The fuel injectors are in flow communication with a common rail or distribution pipe which collects the fuel under high pressure from the fuel pump. During operation of the engine each injector will be supplied with fuel at the same pressure from the common rail or distribution pipe. For this purpose the common rail is provided with one or more fuel outlets, which lead to a respective fuel injector and one or more fuel inlets from the fuel pump.

A method of manufacturing such common rails or fuel distribution pipes is by extruding aluminum. According to this method, heated aluminum is pressed through a die whereby long profiles of uniform cross sectional form, either with a solid profile or a hollow profile, as is the case in the manufacture of a tube. The length of the extruded profile is usually standardized, and they are then cut to the desired length depending on the application. In the above mentioned case with an extruded common rail or fuel distribution pipe, i.e. en elongated body with a hollow profile, the ends of the common rail will be completely open. As long as the openings are not to have a function, for example by connecting to a return conduit or the like, they need to be sealed.

One method of sealing an opening is with the aid of a sealing plug. Since the common rail or distribution pipe will be subjected to high inner pressure it is important that the sealing plug be securely fixed in the opening so that it will not loosen during engine operation.

For this purpose, the sealing plug can be provided with external threads for engagement with corresponding internal threads in the opening. Another method is to force fit the sealing plug in the opening or to weld the sealing plug in the opening (see for example U.S. Pat. No. 3,872,891 and US 2003/0188715 A1).

A disadvantage with these methods of fixation is that they are expensive and/or time consuming (for example the solution with threads requires additional processing with the aid of a threading die and the required wall thickness) force fitting requires exact tolerances in manufacturing both the pipe and the sealing plug, and welding requires welding equipment adapted to aluminum.

### SUMMARY OF THE INVENTION

One purpose of the present invention is thus to provide a method of sealing a common rail or fuel distribution pipe which can be performed in a simple and inexpensive manner.

This purpose is achieved in the present invention with a method with the characteristics decided in the characterizing clause of claim 1.

The purpose is also achieved with a joint with the characterizing features recited in the characterizing clause of claim 7.

A sealing plug is inserted in the opening and positioned so far into the channel that when a stamping tool with a outer diameter which is somewhat larger than the inner diameter of the opening is applied perpendicularly to the end surface and concentric with the opening, the part of the end surface which constitutes the periphery of the opening is deformed plastically and is pressed into the channel to form an abutment outside the sealing plug and with an inner diameter which is less than the outer diameter of the sealing plug. This provides a number of advantages. Firstly, the sealing plug will be locked into the channel in the axial direction against movement out of the opening when there is overpressure in the channel, which secures that it will be held in place. Secondly, the abutment formed by the stamping will in itself constitute a seal since the portion of the material which is pressed down during the stamping is wedged particularly between the sealing plug and the inner walls of the channel. Furthermore a fuel distribution pipe does not need to be premachined in any manner, i.e. by providing the inner surface of the channel with threads, and it does not need to have the same tolerances as for force fitting as regards the diameters of the opening and the sealing plug. Consequently, the above fixation method for the sealing plug achieves a simple and inexpensive method of sealing a tubular body.

Preferably a support is arranged inside the channel to function as an abutment for the sealing plug when it is positioned in the channel. This secures correct positioning depth for the sealing plug in the channel.

The portion of the periphery of the opening which is deformed is suitably the portion which the stamping tool overlaps, and more suitably the inner diameter of the opening is 19 mm and the outer diameter of the stamping tool is 20 mm.

Preferably, the tubular body is made by extrusion of aluminum, and more preferably the tubular body is a fuel distribution pipe intended for an internal combustion engine. The extrusion itself entails a need for end sealing, when the extruded material is pressed through a die and leaves open ends. Aluminum is a material easily malleable for the purpose which is suitable for this type of method.

The sealing plug is suitable made of copper. This is a soft material which can be deformed somewhat when the opening is deformed plastically and is pressed into the channel to form the shoulder.

Preferably, the sealing plug is provided with a gasket for a sealing against the surrounding walls of the outer channel section. The sealing effect can thus be improved.

### DESCRIPTION OF THE FIGURES

The present invention will be described with reference to the accompanying drawings, in which:

FIG. 1 shows a side view in section of one end of a fuel distribution pipe prior to stamping and a stamping tool (19) for use in a method according to the present invention.

FIG. 2 shows a schematic cross section in view of the stamping tool (19) in FIG. 1.

FIG. 3 shows a side view in section of one end of a fuel distribution pipe after stamping.

### DESCRIPTION OF EMBODIMENTS

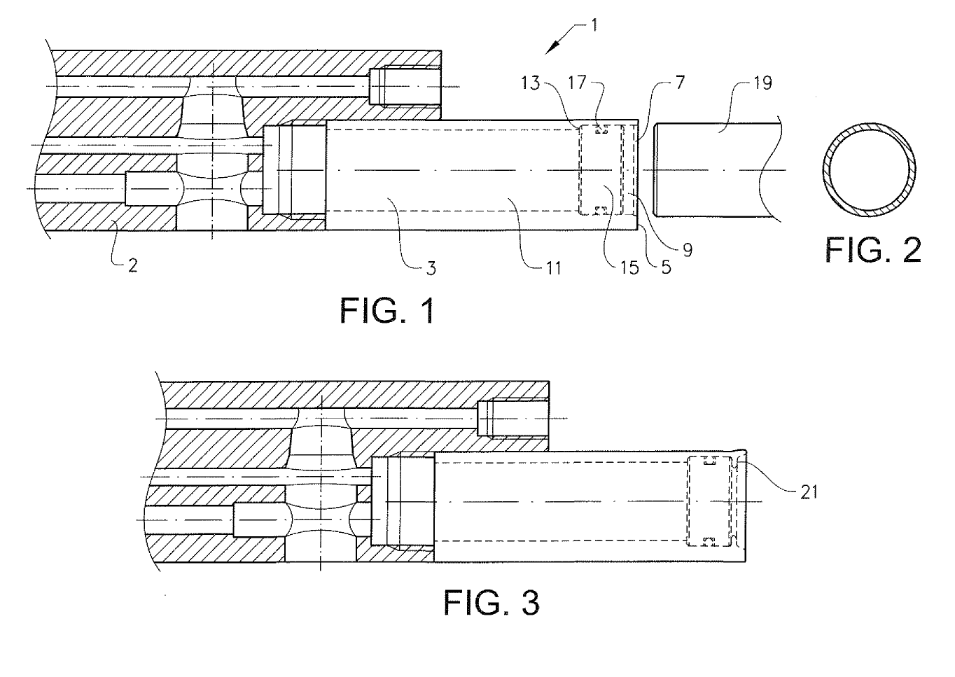

FIG. 1 shows one end of a tubular body in the form of a fuel distribution pipe 1, as seen from the side and in section. The pipe comprises an elongated body 2 with a channel 3 which extends through the entire body 1 from a first end surface 5 of the pipe to a second end surface (not shown) in the pipe. The channel 3 has an opening 7 in the first 5 and the second end of the pipe. The end surface 5 around the opening 7 is substantially flat and perpendicular to the longitudinal direction of the pipe 1. The opening 7 and an outer channel section 9 have a first inner diameter which transitions into a second, smaller inner diameter in an inner channel section 11 so that a substantially flat abutment or support 13 is formed in the transition between the outer 9 and the inner 11 channel section. The support 13 is intended to function as an abutment for a sealing plug 15 of copper, which is inserted in the outer channel section 9 and positioned so that it will abut against the support 13. In this position, the entire sealing plug 15 will be inside the outer channel section and no portion of it will extend out of the opening (even if it is conceivable that only a peripheral portion of the sealing plug will be completely inserted into the outer channel section). The sealing plug 15 is provided with a gasket 17 such as an O-ring for sealing against the surrounding walls of the outer channel section 9.

FIG. 2 shows schematically a stamping tool 19 for use in the method according to the invention. The stamping tool 19 has a circular annular cross section with an outer diameter which is somewhat larger than that of the opening and the inner diameter of the outer channel section 9. According to one embodiment, the inner diameter of the opening is 19 mm and the outer diameter of the stamping tool is 20 mm with a bevel of 0.3 mm×45°.

When sealing the fuel distribution pipe 1, the sealing plug 15 is inserted in the opening 7 and is positioned in the outer channel section 9 so that it abut against the support 13. According to FIG. 1, the entire sealing plug 15 is now within the outer channel section 9 without any portion of the sealing plug 15 protruding out of the opening 7.

The fuel distribution pipe 1 is then placed in a clamp or corresponding fixing means so that it is held securely. The stamping tool 19 is positioned above the opening 7 so that the cross section of the stamping tool is concentric with the cross section of the opening. During this time the sealing plug 15 is in place in the outer channel section in abutment against the support 13.

During the stamping process itself, the stamping tool moves perpendicularly to the end surface 5. The stamping tool 19 will strike a portion of the surrounding periphery of the opening 7, corresponding to the difference in diameter between the stamping tool 19 and the opening 7. Since the fuel distribution pipe 1 is firmly fixed during the stamping and during the continued movement downward of the stamping tool, the material of the pipe 1 will be deformed, i.e. the channel wall will be deformed plasticly and the surrounding periphery of the opening will be pressed or upset down into the outer channel section 9. After a completed impact, i.e. somewhat above the upper surface of the sealing plug 15, the stamping tool 19 is removed. It is evident from FIG. 3 that a shoulder 21 is formed as a result of the stamping in the outer channel section 9 somewhat above the upper surface above the sealing plug 15. The shoulder 21, due to the fact that the wall material of the outer channel section 9 is pressed down, has an inner diameter which is someone less than the outer diameter of the sealing plug. In other words it forms a narrow portion in the outer channel section. The sealing plug 15 is now locked in the axial direction of the channel section 9, both in the inward direction because of the support 13 and in the outward direction due to the shoulder 21 formed. The shoulder acts not only to fix the sealing plug 15 axially in the outer channel section 9 but will also complement the sealing function of the O-ring due to the fact that some material will be wedged in between the sealing plug and the channel wall. The fact that the sealing plug 15 is made of copper improves the sealing effect, since the material yields when the channel wall is pressed down into the outer channel section. After stamping, the sealing plug will be permanently mounted, i.e. it cannot be disassembled.

Suitably the fuel distribution pipe 1 is made of aluminum, since the pipe as such is preferably extruded and it is simple to deform it plastically in the subsequent stamping step, but other malleable metals are possible.

It is also conceivable that the stamping tool has a solid circular cross section and not a circular annular cross section as described above. I de latter case it is possible to use sealing plugs with a central portion which extends out of the opening after its positioning against the support in the outer channel section, for example a coupling threaded into the sealing plug or the like as long as this portion can be held within the annular shape of the stamping tool and will not be affected by the stamping blow. If there is no portion of the sealing plug which is outside the opening of the outer channel section or the sealing plug is sufficiently far into the outer channel section it is possible to use a stamping tool with a solid circular cross section.

Other applications than a fuel distribution pipe are conceivable, for example a fuel heating housing for an internal combustion engine or other extruded tubular bodies which need end sealing.

It is also conceivable to use other malleable materials than copper in the sealing plug.

The invention also relates to a sealing joint for sealing an opening in a tubular body 1, which comprises at least one channel 3 extending in a longitudinal direction of the body, in which an opening 7 to the channel is formed in the respective end surface of the body. The joint comprises a sealing plug 15 positioned in the channel 3, and a shoulder 21 with an inner diameter which is less than the outer diameter of the sealing plug 15, the shoulder 21 being formed in the channel 3 outside the sealing plug 15 by the portion of the end surface 5 constituting the periphery of the opening 7 being deformed plastically and pressed into the channel 3 to form the shoulder.

1. Method of sealing an opening in a tubular body (1), comprising at least one through channel (3) extending in a longitudinal direction of the body, an opening (7) of the channel being formed in respective end surface (5) of the body, characterized in that a sealing plug (15) is inserted in the opening (7) and is positioned far enough into the channel (3) that when a stamping tool (19) with an outer diameter which is greater than the inner diameter of the opening (7) is applied perpendicularly to the end surface (5) and concentrically to the opening (7), the portion of the end surface (5) constituting the periphery of the opening (7) is deformed plastically and is pressed into the channel (3) to form a shoulder (21) outside the sealing plug (15) with an inner diameter which is less than the outer diameter of the sealing plug (15).

2. Method according to claim 1, wherein a support (13) is arranged inside the channel (3) to function as abutment for the sealing plug (15) when it is positioned in the channel (3).

3. Method according to claim 1, wherein the portion of the periphery of the opening (7) which is deformed is the portion which overlaps the stamping tool.

4. Method according to claim 1, wherein the inner diameter of the opening (7) is 19 mm and the outer diameter of the stamping tool is 20 mm.

5. Method according to claim 1, wherein the tubular body (1) is made by extruding aluminum.

6. Method according to claim 1, wherein the tubular body (1) is a fuel distribution pipe intended for en internal combustion engine.

7. Sealing joint for sealing an opening in a tubular body (1), comprising at least one through channel (3) extending in a longitudinal direction of the body, an opening (7) of the channel being formed in a respective end surface (5) of the body,
characterized in that the joint comprises:
a sealing plug (15) positioned in the channel (3), and
a shoulder (21) with an inner diameter which is less than the outer diameter of the sealing plug (15), where the shoulder (21) is formed in the channel (3) outside the sealing plug (15) by that portion of the end surface (5) comprising the periphery to the opening (7) being deformed plastically and pressed into the channel (3) to form the shoulder.

8. Joint according to claim 7, wherein the tubular body (1) is made of extruded aluminum.

9. Joint according to claim 7, wherein the tubular body (1) is a fuel distribution pipe intended for an internal combustion engine.

10. Joint according to claim 7, wherein the sealing plug (15) is made of copper.

11. Joint according to claim 7, wherein the sealing plug (15) is provided with a gasket (17) for sealing against the surrounding walls of the outer channel section (9).

12. Method according to claim 2, wherein the portion of the periphery of the opening (7) which is deformed is the portion which overlaps the stamping tool.

13. Method according to claim 2, wherein the inner diameter of the opening (7) is 19 mm and the outer diameter of the stamping tool is 20 mm.

14. Method according to claim 3, wherein the inner diameter of the opening (7) is 19 mm and the outer diameter of the stamping tool is 20 mm.

15. Method according to claim 2, wherein the tubular body (1) is made by extruding aluminum.

16. Method according to claim 3, wherein the tubular body (1) is made by extruding aluminum.

17. Method according to claim 4, wherein the tubular body (1) is made by extruding aluminum.

18. Method according to claim 2, wherein the tubular body (1) is a fuel distribution pipe intended for en internal combustion engine.

19. Method according to claim 3, wherein the tubular body (1) is a fuel distribution pipe intended for en internal combustion engine.

20. Method according to claim 4, wherein the tubular body (1) is a fuel distribution pipe intended for en internal combustion engine.
